(19) United States
(12) Patent Application Publication
(10) Pub. No.: US 2026/0205245 A1
(43) Pub. Date: Jul. 16, 2026

(54) COMMON INTERFERENCE COVARIANCE ESTIMATION REFERENCE SIGNAL CONFIGURATION ACROSS WIRELESS COMMUNICATION CELLS

(71) Applicant: QUALCOMM Incorporated, San Diego, CA (US)

(72) Inventors: Chih-Hao LIU, San Diego, CA (US); Jing SUN, San Diego, CA (US); Jing JIANG, San Diego, CA (US); Morteza SOLTANI, San Diego, CA (US)

(21) Appl. No.: 19/018,603

(22) Filed: Jan. 13, 2025

(51) Int. Cl. H04L 5/00; H04W 72/1268

(52) U.S. Cl. CPC H04L 5/005; H04W 72/1268

(57) ABSTRACT

Methods, systems, and devices for wireless communications are described. A network entity may obtain control signaling indicating an inter-cell reference signal configuration for a set of reference signals associated with estimation of a covariance matrix, where the inter-cell reference signal configuration allocates a set of transmission occasions for transmission of the set of reference signals within a first cell and one or more second cells different from the first cell. The set of transmission occasions may be at least partially overlapping in time and frequency. The network entity may output second control signaling that indicates the set of transmission and may communicate, with one or more user equipment (UEs) within the first cell of the network entity and via one or more transmission occasions in accordance with the first control signaling and the second control signaling, one or more reference signals of the for the estimation of the covariance matrix.

### FIELD OF TECHNOLOGY

The following relates to wireless communications, including common interference covariance estimation reference signal configuration across wireless communication cells.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a network entity is described. The method may include obtaining first control signaling that indicates an inter-cell reference signal configuration for a set of multiple reference signals associated with estimation of a covariance matrix, where the inter-cell reference signal configuration allocates a set of multiple transmission occasions for transmission of the set of multiple reference signals within a first cell including the network entity and one or more second cells different from the first cell, and where the set of multiple transmission occasions are at least partially overlapping in time and frequency, outputting, in accordance with the inter-cell reference signal configuration, second control signaling that indicates the set of multiple transmission occasions for the set of multiple reference signals, and communicating, with one or more user equipment (UEs) within the first cell of the network entity and via one or more transmission occasions of the set of multiple transmission occasions in accordance with the first control signaling and the second control signaling, one or more reference signals of the set of multiple reference signals for the estimation of the covariance matrix.

A network entity for wireless communications is described. The network entity may include one or more memories storing processor executable code, and one or more processors coupled with the one or more memories. The one or more processors may individually or collectively be operable to execute the code to cause the network entity to obtain first control signaling that indicates an inter-cell reference signal configuration for a set of multiple reference signals associated with estimation of a covariance matrix, where the inter-cell reference signal configuration allocates a set of multiple transmission occasions for transmission of the set of multiple reference signals within a first cell including the network entity and one or more second cells different from the first cell, and where the set of multiple transmission occasions are at least partially overlapping in time and frequency, output, in accordance with the inter-cell reference signal configuration, second control signaling that indicates the set of multiple transmission occasions for the set of multiple reference signals, and communicate, with one or more UEs within the first cell of the network entity and via one or more transmission occasions of the set of multiple transmission occasions in accordance with the first control signaling and the second control signaling, one or more reference signals of the set of multiple reference signals for the estimation of the covariance matrix.

Another network entity for wireless communications is described. The network entity may include means for obtaining first control signaling that indicates an inter-cell reference signal configuration for a set of multiple reference signals associated with estimation of a covariance matrix, where the inter-cell reference signal configuration allocates a set of multiple transmission occasions for transmission of the set of multiple reference signals within a first cell including the network entity and one or more second cells different from the first cell, and where the set of multiple transmission occasions are at least partially overlapping in time and frequency, means for outputting, in accordance with the inter-cell reference signal configuration, second control signaling that indicates the set of multiple transmission occasions for the set of multiple reference signals, and means for communicating, with one or more UEs within the first cell of the network entity and via one or more transmission occasions of the set of multiple transmission occasions in accordance with the first control signaling and the second control signaling, one or more reference signals of the set of multiple reference signals for the estimation of the covariance matrix.

A non-transitory computer-readable medium storing code for wireless communications is described. The code may include instructions executable by one or more processors to obtain first control signaling that indicates an inter-cell reference signal configuration for a set of multiple reference signals associated with estimation of a covariance matrix, where the inter-cell reference signal configuration allocates a set of multiple transmission occasions for transmission of the set of multiple reference signals within a first cell including the network entity and one or more second cells different from the first cell, and where the set of multiple transmission occasions are at least partially overlapping in time and frequency, output, in accordance with the inter-cell reference signal configuration, second control signaling that indicates the set of multiple transmission occasions for the set of multiple reference signals, and communicate, with one or more UEs within the first cell of the network entity and via one or more transmission occasions of the set of multiple transmission occasions in accordance with the first control signaling and the second control signaling, one or more reference signals of the set of multiple reference signals for the estimation of the covariance matrix.

Some examples of the method, network entities, and non-transitory computer-readable medium described herein may further include operations, features, means, or instructions for outputting scheduling information that schedules communications, within the first cell, via one or more shared data channels and that schedules transmissions of the one or more reference signals of the set of multiple reference signals via the one or more transmission occasions of the set of multiple transmission occasions in accordance with the inter-cell reference signal configuration.

In some examples of the method, network entities, and non-transitory computer-readable medium described herein, communicating with the one or more UEs within the first cell may include operations, features, means, or instructions for outputting the communications via a downlink shared data channel of the one or more shared data channels in accordance with the scheduling information and outputting the one or more reference signals of the set of multiple reference signals via the one or more transmission occasions of the set of multiple transmission occasions in accordance with the inter-cell reference signal configuration and the scheduling information.

In some examples of the method, network entities, and non-transitory computer-readable medium described herein, communicating with the one or more UEs within the first cell may include operations, features, means, or instructions for obtaining the communications via an uplink shared data channel of the one or more shared data channels in accordance with the scheduling information, obtaining the one or more reference signals of the set of multiple reference signals via the one or more transmission occasions of the set of multiple transmission occasions in accordance with the inter-cell reference signal configuration and the scheduling information, and estimating the covariance matrix in accordance with the one or more reference signals of the set of multiple reference signals.

In some examples of the method, network entities, and non-transitory computer-readable medium described herein, obtaining the first control signaling may include operations, features, means, or instructions for obtaining, via the first control signaling, an indication of a time offset, a frequency offset, or both within a common time and frequency resource grid and associated with the inter-cell reference signal configuration, where the time offset includes an offset in time from an initial time domain index of the common time and frequency resource grid and the frequency offset includes an offset in frequency from an initial frequency domain index of the common time and frequency resource grid, and where the set of multiple transmission occasions output via the second control signaling may be in accordance with the time offset, the frequency offset, or both.

In some examples of the method, network entities, and non-transitory computer-readable medium described herein, the set of multiple transmission occasions includes a first subset of transmission occasions associated with the first cell and one or more second subsets of transmission occasions associated with the one or more second cells, each transmission occasion of the first subset of transmission occasions at least partially overlapping in time and frequency with a respective transmission occasion in each of the one or more second subsets of transmission occasions in accordance with the common time and frequency resource grid.

In some examples of the method, network entities, and non-transitory computer-readable medium described herein, communicating with the one or more UEs within the first cell may include operations, features, means, or instructions for communicating, in accordance with the inter-cell reference signal configuration, the one or more reference signals via a first subset of transmission occasions from among the set of multiple transmission occasions allocated for the set of multiple reference signals and communicating, in accordance with the inter-cell reference signal configuration and one or more communication parameters associated with one or more data signals, the one or more data signals via a second subset of transmission occasions from among the set of multiple transmission occasions allocated for the set of multiple reference signals.

Some examples of the method, network entities, and non-transitory computer-readable medium described herein may further include operations, features, means, or instructions for outputting third control signaling that schedules communications within the set of multiple transmission occasions and indicates that the communications include the set of multiple reference signals and the one or more data signals.

In some examples of the method, network entities, and non-transitory computer-readable medium described herein, the one or more communication parameters associated with the one or more data signals include a modulation order of the one or more data signals, a quantity of data channel layers associated with the one or more data signals, or both and the modulation order of the one or more data signals may be in accordance with a location of the one or more UEs within the first cell.

Some examples of the method, network entities, and non-transitory computer-readable medium described herein may further include operations, features, means, or instructions for refraining from communicating a first reference signal of the set of multiple reference signals within a first symbol of a first transmission occasion of the set of multiple transmission occasions in accordance with the first symbol of the first transmission occasion including a demodulation reference signal (DMRS) and communicating one or more second reference signals of the set of multiple reference signals within one or more second symbols of the first transmission occasion of the set of multiple transmission occasions in accordance with the first symbol including the DMRS and in accordance with an absence of one or more additional DMRSs within the one or more second symbols.

In some examples of the method, network entities, and non-transitory computer-readable medium described herein, communicating the one or more reference signals of the set of multiple reference signals may include operations, features, means, or instructions for communicating the one or more reference signals with a first subset of UEs from among the one or more UEs within the first cell in accordance with a first location of the first subset of UEs and refraining from communicating the one or more reference signals with a second subset of UEs from among the one or more UEs within the first cell in accordance with a second location of the second subset of UEs.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports common interference covariance estimation reference signal configuration across wireless communication cells in accordance with one or more aspects of the present disclosure.

FIG. 2 shows an example of a wireless communications system that supports common interference covariance estimation reference signal configuration across wireless communication cells in accordance with one or more aspects of the present disclosure.

FIG. 3 shows an example of a reference signal configuration that supports common interference covariance estimation reference signal configuration across wireless communication cells in accordance with one or more aspects of the present disclosure.

FIG. 4 shows an example of a process flow that supports common interference covariance estimation reference signal configuration across wireless communication cells in accordance with one or more aspects of the present disclosure.

FIGS. 5 and 6 show block diagrams of devices that support common interference covariance estimation reference signal configuration across wireless communication cells in accordance with one or more aspects of the present disclosure.

FIG. 7 shows a block diagram of a communications manager that supports common interference covariance estimation reference signal configuration across wireless communication cells in accordance with one or more aspects of the present disclosure.

FIG. 8 shows a diagram of a system including a device that supports common interference covariance estimation reference signal configuration across wireless communication cells in accordance with one or more aspects of the present disclosure.

FIGS. 9 through 11 show flowcharts illustrating methods that support common interference covariance estimation reference signal configuration across wireless communication cells in accordance with one or more aspects of the present disclosure.

### DETAILED DESCRIPTION

Reference signals associated with estimation of interference covariance matrixes may be exchanged between a user equipment (UE) and a network entity within a same cell. The reference signals may be associated with a known signal level, such that the devices may measure the reference signals to estimate interference and support inter-cell interference coordination. Network entities in multiple neighboring cells may similarly exchange reference signals for interference estimation within their respective cells. However, the network entities may not collaborate regarding such transmissions, such that a first pattern for covariance estimation reference signal transmission within a first cell may be unaligned (e.g., in time, in frequence, or in both) with transmission opportunities scheduled for transmission and reception of reference signals in other neighboring cells. Thus, a data transmission or other transmission associated with a relatively high modulation order by a device in the first cell may overlap in time, frequency, or both with a reference signal transmission in the second cell, and the higher order transmission may negatively impact the interference estimation performed in the first cell.

The techniques, methods, and devices described herein may enable multiple cells to be configured with a common covariance estimation reference signal configuration. For example, a network operator may configure multiple neighboring cells with a common covariance estimation configuration. The common configuration may be based on a common time and frequency grid, which includes a common (e.g., baseline) set of time resources and frequency resources associated with each cell of the neighboring cells. Accordingly, each covariance estimation reference signal transmission occasion that is scheduled within the first cell may be aligned in time and in frequency with each covariance estimation reference signal transmission occasion for the second cell based on the common configuration. The network entity may output an indication of the common covariance estimation reference signal configuration to one or more UEs associated with the first cell and may subsequently schedule data transmissions, reference signal transmissions, or both in accordance with the common configuration.

The network entity may communicate the covariance estimation reference signals with each device in the first cell, or the network entity may communicate the covariance estimation reference signals with a subset of the devices based on various parameters. Additionally, or alternatively, the network entity may communicate one or more data signals (e.g., rate match data signals) via the one or more transmission occasions for the covariance estimation reference signal according to a modulation order of the data communications, a location of an associated UE relative to the network entity, or both.

By communicating according to a common covariance estimation reference signal configuration, one or more devices (e.g., network entities, UEs, or the like) may accurately estimate inter-cell interference, which may correspondingly improve communication reliability. Additionally, or alternatively, by performing a rate matching of data signals via one or more transmission occasions for the common covariance estimation reference signals in accordance with a location of one or more UEs, the network entity and the UEs may achieve a more efficient utilization of communication resources, among other examples.

Aspects of the disclosure are initially described in the context of wireless communications systems. Aspects of the disclosure are further described in the context of wireless communications systems, reference signal configurations, and process flows. Aspects of the disclosure are further illustrated by and described with reference to apparatus diagrams, system diagrams, and flowcharts that relate to common interference covariance estimation reference signal configuration across wireless communication cells.

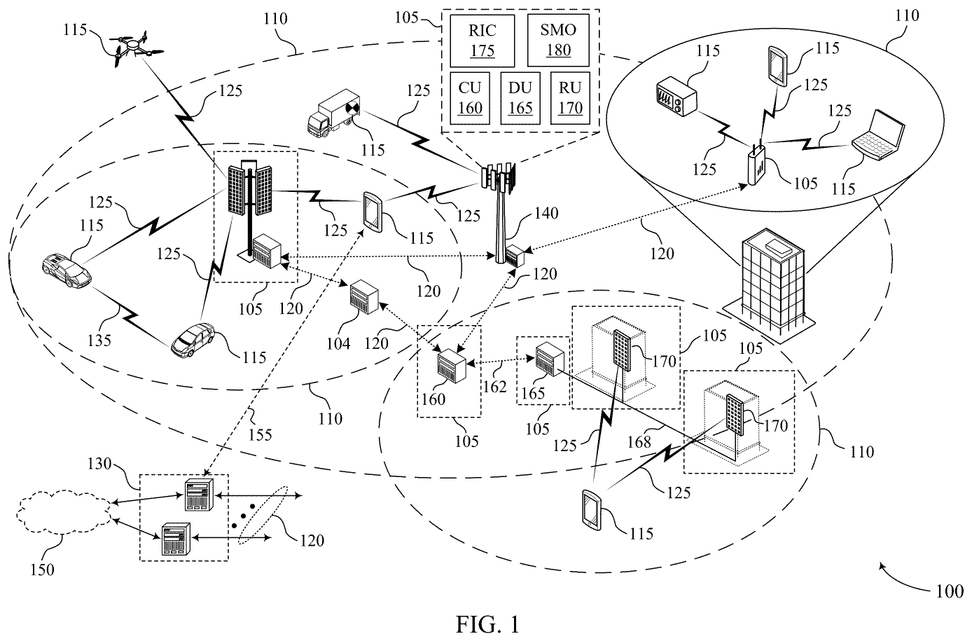

FIG. 1 shows an example of a wireless communications system 100 that supports common interference covariance estimation reference signal configuration across wireless communication cells in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATS).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support common interference covariance estimation reference signal configuration across wireless communication cells as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The techniques, methods, and devices described herein may enable multiple cells (e.g., geographic coverage areas 110) to be configured with a common covariance estimation reference signal configuration. For example, a network operator may configure multiple neighboring cells with a common covariance estimation configuration. The common configuration may be based on a common time and frequency grid, which may include a common (e.g., baseline) set of time resources and frequency resources associated with each cell of the neighboring cells. Accordingly, each covariance estimation reference signal transmission occasion that is scheduled within the first cell may be aligned in time and in frequency with each covariance estimation reference signal transmission occasion for the second cell based on the common configuration. A network entity 105 may output an indication of the common covariance estimation reference signal configuration to one or more UEs 115 associated with the first cell and may subsequently schedule data transmissions, reference signal transmissions, or both in accordance with the common configuration.

The network entity 105 may communicate the covariance estimation reference signals with each device in the first cell, or the network entity 105 may communicate the covariance estimation reference signals with a subset of the devices based on various parameters. Additionally, or alternatively, the network entity 105 may communicate one or more data signals (e.g., rate match data signals) via the one or more transmission occasions for the covariance estimation reference signal according to a modulation order of the data communications, a location of an associated UE 115 relative to the network entity 105, or both.

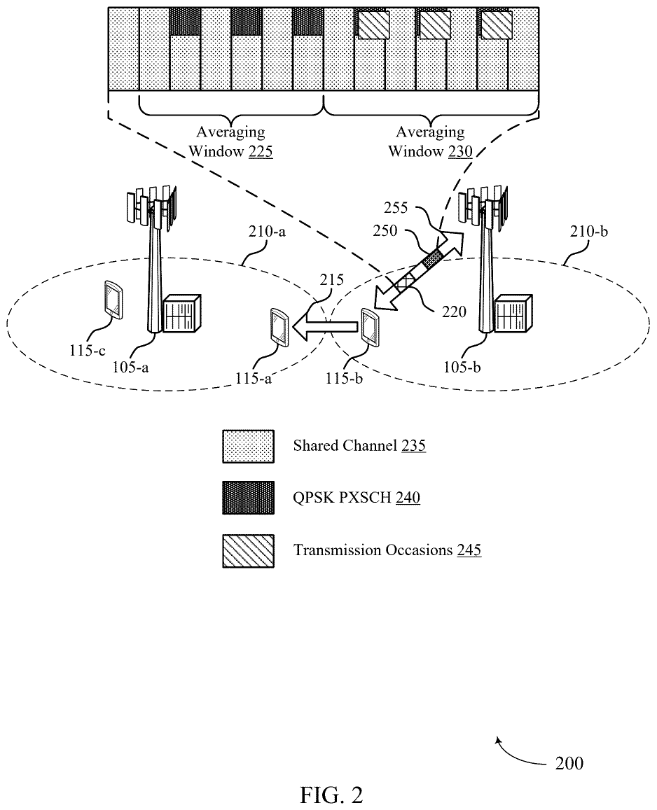

FIG. 2 shows an example of a wireless communications system 200 that supports common interference covariance estimation reference signal configuration across wireless communication cells in accordance with one or more aspects of the present disclosure. Aspects of the wireless communications system 200 may implement or be implemented by aspects of the wireless communications system 100. For example, the wireless communications system 200 may include a network entity 105-a, a network entity 105-b, a UE 115-a, a UE 115-b, and a UE 115-c, which may be examples of the network entity 105 and the UEs 115, respectively, as described with reference to FIG. 1. The network entity 105-a may support communications with at least the UE 115-c and the UE 115-a within the cell 210-a, and the network entity 105-b may support communications with at least the UE 115-b within the cell 210-b. The cells 210-a and 210-b may represent examples of a geographic coverage area 110, as described with reference to FIG. 1.

In some cases, an inter-cell interference coordination (ICIC) framework (e.g., Xn messages, or an Xn interface, among other examples) may enable neighboring cells 210 to exchange potential start and length indicator value (SLIV) patterns, a frequency domain resource allocation (FDRA), and one or more physical resource block groups (PRGs) configurations such that a target cell 210 may configure time domain and frequency domain averaging boundaries for covariance matrix estimation. The ICIC framework may additionally, or alternatively, enable neighboring cells to exchange covariance matrix estimation (e.g., Rnn) reference signals (Rnn RSs) or data carrying reference signals (DC-RSs) within each averaging window to capture the uplink interference from the neighboring cells 210, downlink interference from the neighboring cells 210, or both (e.g., bursty interference, among other examples).

In some cases, a frequency domain covariance estimation window (e.g., Rnn window) may be aligned with a PRG size from the neighboring cells 210, and a network entity 105 (e.g., associated with a target cell 210) may configure a time domain averaging start boundary and end boundary (e.g., a time domain window duration, or the like) according to the potential SLIV patterns associated with the neighboring cells 210. For each ICIC period, each cell of the neighboring cells 210 may update interference patterns and may indicate the updated interference cells to the one or more neighboring cells 210. Accordingly, the target cell 210 may update a corresponding covariance matrix averaging window (e.g., time domain window and frequency domain window), a covariance matrix estimation reference signal pattern, or both.

In some cases, the network entity 105 may configure the covariance matrix estimation averaging windows based on an interference pattern associated with the neighboring cells 210 (e.g., time domain and frequency domain interference patterns). For example, if there are no demodulation reference signals (DMRSs) present in a covariance matrix estimation averaging window, the network entity 105 may configure relatively low density (e.g., low frequency density, low time density, or both) covariance matrix estimation reference signals.

In some cases, the network entity 105 may configure covariance matrix estimation reference signal for each frequency domain window and according to each time domain averaging start and end boundaries. That is, the network entity 105 may configure a transmission of covariance matrix estimation reference signals within each covariance matrix estimation averaging windows. To measure the interference from neighboring cells 210, the network entity 105 may configure relatively low-density reference signals per time segment and per frequency domain window. That is, within each covariance matrix estimation averaging window, the network entity 105 may configure covariance matrix estimation reference signals to be transmitted each X quantity of symbols and each Y quantity of tones with preconfigured symbol and tone offsets (e.g., symbol and tone offsets from a common resource grid).

In some cases, a quantity of covariance matrix estimation reference signals included within each covariance estimation averaging window may be based on a modulation order, a transmission rank, or both corresponding to associated interference (e.g., interfering signals). The quantity of covariance matrix estimation reference signals may further be based on a covariance matrix estimation threshold (e.g., a threshold normalized mean square error (NMSE), among other examples). For example, a device may utilize relatively fewer covariance estimation reference signals in each PRG to attain the threshold interference estimation for interference associated with signals of a relatively low modulation order (e.g., quadrature phase shift keying (QPSK) interference) compared to interference associated with signals of a relatively greater modulation order (e.g., quadrature amplitude modulation (QAM) interference, or 64 QAM interference, among other examples). In such examples, for a threshold interference estimation of negative 10 decibels (dB) NMSE, among other example thresholds, the device may utilize 12 covariance matrix estimation reference signal resource elements (REs) for QPSK interference and 36 covariance matrix estimation reference REs for 64 QAM interference, as an example. Generally, the device may utilize a greater quantity of samples (e.g., covariance matrix estimation reference signals) to average over possible interference values when computing the sample variance for interference signals having a greater quantity of constellation points (e.g., associated with a greater modulation order).

In some cases, ICIC signaling (e.g., Xn signaling) may enable network entities 105 for neighboring cells 210 to agree on (e.g., configure) a common covariance matrix estimation reference signal configuration via one or more consensus algorithms such that interference during one or more ICIC periods is limited to QPSK signaling. Accordingly, one or more devices associated with the neighboring cells 210 may utilize relatively fewer covariance matrix estimation reference signal REs. Additionally, or alternatively, the neighboring cells 210 may utilize one or more different covariance matrix estimation reference signal configurations and may update the different configurations to adapt the covariance matrix estimation reference signals to different interference patterns. In such cases, one or more interference covariance estimation reference signal patterns associated with the neighboring cells 210 may accommodate each interference pattern associated with the group of neighboring cells 210, which may increase signaling overhead. That is, the neighboring cells 210 may communicate a greater quantity of interference covariance estimation reference signals based on a greater quantity of interference patterns.

A network operator (e.g., another network entity, node, server, or the like that is coupled with multiple network entities 105 via one or more backhaul communication links) may, in some cases, configure a common covariance matrix estimation reference signal configuration across each cell 210 of the neighboring cells 210 (e.g., for each possible interference pattern). In such cases, configuring a common covariance matrix estimation reference signal pattern may include a relatively denser pattern of (e.g., a greater quantity of) covariance matrix estimation reference signals in the time domain, the frequency domain, or both to accommodate (e.g., provide interference measurements for) various SLIV patterns. Accordingly, in some cases, a network entity may utilize DC-RS to convey the covariance matrix estimation reference signals, which may include iterative hard slicing by a de-mapper (e.g., at a receiving device, such as a UE 115, among other examples) to reconstruct the reference signals. QPSK may utilize one iteration of hard slicing, while higher order QAM may utilize four or more iterations of hard slicing. Accordingly, QPSK DC-RS may balance implementation complexity and reference signal overhead (e.g., such as when a scheduled data signal has a higher modulation order than an associated DC-RS).

Additionally, or alternatively, in some cases, network entities 105 of one or more neighboring cells 210 may be unable to coordinate a common covariance matrix estimation reference signal (e.g., interference covariance estimation reference signal) pattern.

The techniques, methods, and devices described herein may enable neighboring cells 210 to support a common interference covariance estimation reference signal configuration (e.g., an inter-cell reference signal configuration, or an Rnn reference signal configuration) across wireless communication cells 210. For example, a network operator (e.g., a central network entity, among other examples) may coordinate a common interference covariance estimation reference signal configuration and may indicate the common interference covariance estimation reference signal configuration to network entities 105 within one or more neighboring cells 210, such as to the network entities 105-a and 105-b within the cells 210-a and 210-b, respectively, in FIG. 2. Accordingly, the one or more neighboring cells 210 may apply the common interference covariance estimation reference signal configuration.

In some implementations, the network operator may configure one or more neighboring cells 210 with a common interference covariance estimation reference signal configuration (e.g., an interference covariance estimation reference signal pattern). For example, a cell 210-a and a cell 210-b may be neighboring cells 210. Accordingly, the network operator may configure the network entity 105-a and the network entity 105-b, which may be associated with the cell 210-a and the cell 210-b respectively, with the common interference covariance estimation reference signal configuration. For example, the network operator may transmit control signaling that indicates the common interference covariance estimation reference signal configuration (e.g., an inter-cell reference signal configuration for a set of multiple reference signals) to the network entity 105-a and the network entity 105-b and indicates (e.g., instructs, among other examples) for the network entity 105-a and the network entity 105-b to apply the configuration. The network operator may indicate the common interference covariance estimation reference signal configuration via radio resource control (RRC) signaling, or some other type of control signaling.

In some implementations, the network operator may identify (e.g., determine, or derive, among other examples) the common interference covariance estimation reference signal configuration based on a topology of the network such as an association between the network entity 105-a, the network entity 105-b, and one or more UEs 115 associated with the network entity 105-a and the network entity 105-b, or the like. For example, the network operator may determine the common interference covariance estimation reference signal configuration based on a location (e.g., distance, or position) of the UEs 115 relative to a network entity 105. Additionally, or alternatively, the network operator may further determine the common interference covariance estimation reference signal configuration based on one or more SLIV patterns associated with the neighboring cells 210, one or more PRGs of the neighboring cells 210, or both, among other examples.

Each network entity 105 that receives the control signaling from the network operator may configure one or more UEs 115 associated with a respective cell 210 of the network entity 105 with the common interference covariance estimation reference signal configuration. For example, the network entity 105-a may transmit control signaling to the UE 115-a and the UE 115-b to indicate the common interference covariance estimation reference signal configuration (e.g., the network entity 105-a may forward the configuration). Additionally, or alternatively, the network entity 105-b may transmit an indication (e.g., via control signaling) of the common interference covariance estimation reference signal configuration to the UE 115-c. The network entity 105-a, the network entity 105-b, or both may indicate the common interference covariance estimation reference signal configuration to the UE 115-a, the UE 115-b, the UE 115-c, or any combination thereof via control signaling 220, which may be RRC signaling, among other examples.

In some examples, the network entity 105-a, the network entity 105-b, or both may utilize each link 255 (e.g., each uplink, each downlink, or both, among other examples) of a set of links associated with communications for the cell 210-a and the cell 210-b. For example, the network entity 105-b may communicate with the UE 115-b via a link 255, and the network entity 105-a may communicate with the UE 115-a and the UE 115-c via one or more respective uplinks, one or more respective downlinks (e.g., one uplink and one downlink for each associated device), or any combination thereof. Accordingly, the network entity 105-a may communicate the interference covariance estimation reference signals according to the common interference covariance estimation reference signal configuration for each of the respective uplinks and downlinks.

In some other examples, the network entity 105-a, the network entity 105-b, or both may apply the common interference covariance estimation reference signal configuration for one or more UEs 115 on a per-link basis. For example, the network entities 105-a and 105-b may turn interference covariance estimation reference signals on or off per link based on a location (e.g., a position, or distance, among other examples) of the UEs 115 relative to the network entity 105-a and the network entity 105-b. That is, the network entity 105-a and the network entity 105-b may apply the common interference covariance estimation reference signal configuration for a first subset of the set of links associated with the cell 210-a and the cell 210-b, and may refrain from applying the common interference covariance estimation reference signal configuration for a second subset of the set of links.

For example, the UE 115-c may be located relatively close to the network entity 105-a, and may accordingly be relatively unlikely to cause (e.g., induce) interference in a different cell, may be relatively unlikely to receive interference from a different cell, or both. Accordingly, the network entity 105-a may refrain from applying (e.g., refrain from scheduling) the common interference covariance estimation reference signal configuration for one or more links (e.g., uplink, downlink, or both) associated with the UE 115-c (e.g., common interference covariance estimation reference signal configuration off for the UE 115-c), but may apply the common interference covariance estimation reference signal configuration for one or more links associated with one or more other UEs 115 such as the UE 115-a that are further away from the network entity 105-a (e.g., at least a threshold distance from the network entity 105-a). Additionally, or alternatively, the network entity 105-a may schedule one or more edge link devices (e.g., the UE 115-b, among other examples) with QPSK transmissions based on the edge link devices being relatively likely to cause interference on or receive interference from one or more different cells.

Additionally, or alternatively, in another example, the UE 115-b may be relatively far from the network entity 105-b and may be correspondingly located at the edge of the cell 210-b (e.g., cell edge device). In such examples, the UE 115-b may be relatively likely to cause interference, receive interference, or both from a neighboring cell such as the cell 210-a. For example, the network entity 105-b may cause interference for the UE 115-a via an interference link 215, among other examples. Accordingly, the network entity 105-b may apply the common interference covariance estimation reference signal configuration (e.g., cell specific reference signals) for one or more links (e.g., uplinks, downlinks, or both) associated with the UE 115-b, and may communicate the interference covariance estimation reference signals via outputting the interference covariance estimation reference signals, obtaining the interference covariance estimation reference signal, or both.

In some implementations, the network entity 105-a, the network entity 105-b, or both may output an indication, to the network entity 105-a, the network entity 105-b, the network entity 105-c, or any combination thereof, of one or more covariance matrix estimation averaging windows. For example, the network entity 105-b may determine and indicate (e.g., via control signaling, or the like) a covariance matrix estimation averaging window 225 and a covariance matrix estimation averaging window 230, among other examples. The covariance matrix estimation averaging window 225, the covariance matrix estimation averaging window 230, or both may be based on a time domain resource allocation (e.g., corresponding to one or more SLIV patterns, among other examples), a frequency domain resource allocation (e.g., corresponding to one or more PRGs, among other examples), or both. For example, a time domain allocation of the covariance matrix estimation averaging window 225, the covariance matrix estimation averaging window 230, or both may include a set of multiple shared channel slots 235 corresponding to one or more shared channel occasions (e.g., physical downlink shared channel (PDSCH) occasions, physical uplink shared channel (PUSCH) occasions, or both, which may be referred to as PXSCH occasions herein). For example, the covariance matrix estimation averaging window 225, the covariance matrix estimation averaging window 230, or both may include a quantity of QPSK PXSCH occasions 240, which may represent time and frequency resources allocated for transmission of data signals modulated according to QPSK modulation and associated with one or more devices of the cell 210-a and the cell 210-b.

Additionally, or alternatively, the covariance matrix estimation averaging window 225, the covariance matrix estimation averaging window 230, or both may include one or more transmission occasions 245 corresponding to the common interference covariance estimation reference signal configuration. Accordingly, one or more devices associated with the cell 210-a and the cell 210-b such as the UE 115-a and the UE 115-b, among other examples, may perform interference covariance matrix estimation based on one or more interference covariance estimation reference signals being communicated within the one or more transmission occasions 245.

In some implementations, a device may estimate an interference covariance matrix based on the interference covariance estimation reference signals, or based on PXSCH (e.g., PXSCH of a relatively low modulation order such as QPSK, among other examples) within one or more interference covariance estimation reference signal transmission occasions. For example, the device may capture a spatial signature of the interference covariance matrix in one or more interference covariance estimation reference signal RE locations (e.g., one or more assumed interference covariance estimation reference signal transmission occasions). Accordingly, a network operator may apply a sparser (e.g., relatively less frequent) interference covariance estimation reference signal configuration based on a relatively faster convergence for interference covariance estimation (e.g., for lower modulation order transmissions, or the like).

Additionally, or alternatively, a device such as the network entity 105-a, the network entity 105-b, the UE 115-a, the UE 115-b, the UE 115-c, or the any combination thereof may transmit one or more data signals (e.g., PXSCH signals) within one or more transmission occasions 245 of a set of interference covariance estimation reference signal transmission occasions 245. When a target cell (e.g., a first cell such as the cell 210-a, among other examples) schedules a PXSCH transmission in the interference covariance estimation reference signal transmission occasion locations instead, a receiver (e.g., one or more UEs 115, or the like) may reconstruct constellations (e.g., signal constellation points) before performing an interference covariance matrix estimation. For QPSK transmissions (e.g., PXSCH transmissions), a complexity of the reconstruction may be relatively low, and the interference covariance matrix estimation quality may be similar to an interference covariance matrix estimation associated with interference covariance estimation reference signal transmission. That is, a receiving device (e.g., one or more UEs 115) may perform interference covariance matrix estimation based on receiving a PXSCH transmission, an interference covariance estimation reference signal, or both.

In some implementations, such as when one or more devices are scheduled with QPSK PXSCH transmissions, the devices may transmit PXSCH REs on interference covariance estimation reference signal transmission occasions 245. That is, the device may rate match PXSCH transmissions onto interference covariance estimation reference signal transmission occasions 245. Accordingly, a receiving device may estimate an interference covariance matrix based on reconstructing the constellation points of the PXSCH REs. For example, the network entity 105-a, the UE 115-a, or both may rate match PDSCH or PUSCH REs into the interference covariance estimation reference signal REs via an indication or a rule (e.g., a predefined rule, or a preconfigured rule, among other examples). That is, in the interference covariance estimation reference signal transmission occasions 245, whether to transmit interference covariance estimation reference signals or to allow PXSCH to rate match into the interference covariance estimation reference signal resources may be based on an indication (e.g., a rate matching indication), a rule, or both. Correspondingly, one or more center UEs 115, such as the UE 115-c may communicate the interference covariance estimation reference signals, or may refrain from communicating the interference covariance estimation reference signals based on signaling, a rule, or both.

In some implementations, the network entity 105-a, the UE 115-a, or both may transmit interference covariance estimation reference signals or rate-matched PXSCH during the interference covariance estimation reference signal transmission occasions 245 based on one or more predefined or preconfigured rules. For example, the network entity 105-a, the UE 115-a, or both may communicate the PXSCH transmissions within the interference covariance estimation reference signal transmission occasions 245 based on a modulation order of the PXSCH transmissions satisfying a threshold (e.g., being less than a threshold modulation order level). In some examples, the network entity 105-a, the UE 115-a, or both may communicate the PXSCH within the transmission occasions 245 based on the PXSCH corresponding to QPSK modulation.

Additionally, or alternatively, the network entity 105-a, the UE 115-a, or both may communicate the PXSCH transmissions within interference covariance estimation reference signal transmission occasions 245 based on a quantity of PXSCH layers (e.g., PXSCH signaling layers, or antenna port layers, among other examples). For example, the network entity 105-a, the UE 115-a, or both may communicate the PXSCH transmissions within the transmission occasions 245 based on a quantity of PXSCH layers satisfying a threshold. In some other examples, the network entity 105-a, the UE 115-a, or both may communicate one or more interference covariance estimation reference signals within the interference covariance estimation reference signal transmission occasions 245 based on the modulation order, the quantity of reference signals, or both.

In some other examples, a network entity may indicate whether to apply PXSCH rate matching via signaling (e.g., explicit interference covariance estimation reference signal triggering). For example, the network entity 105-b may indicate to at least the UE 115-b to perform PXSCH rate matching via control signaling 250. Control signaling 250 may be downlink control information (DCI), higher layer signaling such as Layer 2 (L2) or Layer 3 (L3) signaling, or the like. Accordingly, the UE 115-b may control (e.g., directly control) whether to communicate interference covariance estimation reference signals or PXSCH within the interference covariance estimation reference signal transmission occasions.

By respectively applying the common interference covariance estimation reference signal configuration for the cell 210-a and the cell 210-b, each interference covariance estimation reference signal transmission occasion 245 for the cell 210-a and the cell 210-b may be aligned in time and in frequency. That is, each interference covariance estimation reference signal transmission occasion 245 for the cell 210-a may be communicated according to a same set of time resources and a same set of frequency resources as each interference covariance estimation reference signal transmission occasion 245 for the cell 210-b. As such, the network entity 105-a, the network entity 105-b, the UE 115-a, the UE 115-b, the UE 115-c, or any combination thereof may estimate one or more covariance matrices during the covariance matrix estimation averaging window 225, the covariance matrix estimation averaging window 230, or both in accordance with common interference covariance estimation reference signal configurations, and in accordance with the common interference covariance estimation reference signal configurations applied by the cell 210-a and the cell 210-b being aligned and aligning with the covariance matrix estimation averaging window 225, the covariance matrix estimation averaging window 230, or both. That is, the network entity 105-a, the network entity 105-b, the UE 115-a, the UE 115-b, the UE 115-c, or any combination thereof may estimate the covariance matrices based on signals of an anticipated (e.g., known) signal level, modulation order, or both being included within the one or more transmission occasions 245, and based signals of a different signal level or modulation order not being included within the one or more transmission occasions 245 (e.g., QAM signals instead of expected QPSK signals).

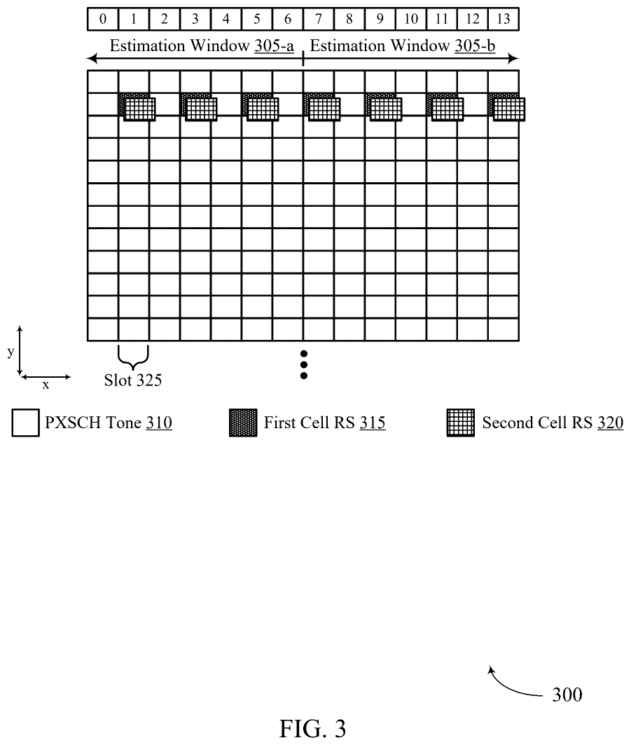

FIG. 3 shows an example of a reference signal configuration 300 that supports common interference covariance estimation reference signal configuration across wireless communication cells in accordance with one or more aspects of the present disclosure. Aspects of the common interference covariance estimation reference signal configuration 300 may implement or be implemented by aspects of the wireless communications system 100, the wireless communications system 200, or both. For example, the common interference covariance estimation reference signal configuration 300 may be implemented by one or more network entities, one or more UEs, or both, which may be examples of the network entity 105 and the UEs 115, respectively, as described with reference to FIGS. 1 and 2.

In some implementations, a common interference covariance estimation reference signal configuration (e.g., an inter-cell reference signal configuration for a set of multiple reference signals, or an Rnn reference signal configuration) may be based on a common time and frequency grid (e.g., a time domain and frequency domain resource grid, or a resource block grid, among other examples). That is, an interference covariance estimation reference signal time and frequency pattern may be defined on a common time and frequency grid rather than with respect to one or more individual PXSCH allocations for each cell of one or more neighboring cells. Accordingly, the common interference covariance estimation reference signal configuration may be aligned (e.g., applied the same) across the one or more neighboring cells, one or more network entities associated with the neighboring cells, one or more UEs, or any combination thereof such that a set of interference covariance estimation reference signals may be communicated according to the set of common time resources, a set of common frequency resources, or both.

In some implementations, the common interference covariance estimation reference signal configuration may be associated with one or more covariance matrix estimation averaging windows 305, including at least a covariance matrix estimation averaging window 305a and a covariance matrix estimation averaging window 305b, among other examples. The covariance matrix estimation averaging window 305a, the covariance matrix estimation averaging window 305b, or both may be associated with a respective quantity of PXSCH tones 310 (e.g., PXSCH occasion REs, among other examples). Additionally, or alternatively, within the covariance matrix estimation windows 305, one or more devices (e.g., such as a UE) may communicate via transmitting, receiving, or both, one or more interference covariance estimation reference signals. For example, within the covariance matrix estimation averaging window 305a, a UE may obtain a respective quantity of first cell reference signals 315, a respective quantity of second cell reference signals 320, or both. In some examples, the first cell reference signals 315 and the second cell reference signals 320 may be aligned in time, in frequency, or in both according to the interference covariance estimation reference signal and the common time and frequency resource grid.

In some implementations, the common interference covariance estimation reference signal configuration may be based on one or more time offsets, frequency offsets, or both according to the common time and frequency grid. For example, each of the first cell reference signals 315, the second cell reference signals 320, or both may be based on a symbol spacing and symbol offset within a slot, where the symbol spacing and the symbol spacing are configured per slot. That is, within a time slot, a time domain location for each interference covariance estimation reference signal of the first cell reference signals 315 and the second cell reference signals 320 (e.g., corresponding to the common interference covariance estimation reference signal configuration) may be indicated by an offset duration of time (e.g., a time interval x) from the beginning of the slot, or the like. Additionally, or alternatively, a spacing between one or more interference covariance estimation reference signals may be based on a spacing in time (e.g., a spacing in time x). For an example, within a slot, a first interference covariance estimation reference signal may correspond to a time offset x1 from the beginning of the slot, and each subsequent interference covariance estimation reference signal may begin at a spacing interval of nx2, where x2 is the spacing in time, and n is a variable corresponding to a respective index of an associated interference covariance estimation reference signal. In such examples, x1 and x2 may be common to one or more devices associated with the neighboring cells.

Additionally, or alternatively, each of the first cell reference signals 315, the second cell reference signals 320, or both may be based on a tone spacing and tone offset (e.g., frequency resource offset and spacing, or RE offset and spacing, among other examples). That is, a frequency domain location for each interference covariance estimation reference signal of the first cell reference signals 315 and the second cell reference signals 320 (e.g., corresponding to the common interference covariance estimation reference signal configuration) may be indicated by a frequency offset from a common reference point of a common resource block (CRB) grid, or the like. For example, the frequency offset may be an offset from a common Point A (e.g., with respect to Point A), or the like. Additionally, or alternatively, a frequency spacing between one or more interference covariance estimation reference signals may be based on a spacing in frequency (e.g., a spacing in frequency y). For an example, a first interference covariance estimation reference signal may correspond to a frequency offset y1 from the beginning of the slot, and each subsequent interference covariance estimation reference signal may begin at a spacing interval of ny2, where y2 is the spacing in frequency, and n is a variable corresponding to a respective index of an associated interference covariance estimation reference signal. Accordingly, a device may transmit each interference covariance estimation reference signal within one or more resource blocks (RBs) allocated according to the frequency offset and spacing. In such examples, y1 and y2 may be common to one or more devices associated with the neighboring cells.

In such examples, a device may transmit each interference covariance estimation reference signal of the first cell reference signals 315, the second cell reference signals 320, or both within a time domain and frequency domain PXSCH allocation. That is, the device may transmit the interference covariance estimation reference signals within a PXSCH resource allocation, where the time domain and frequency domain resources corresponding to the respective interference covariance estimation reference signal is based on the time offset, time spacing, frequency offset, frequency spacing, or any combination thereof. Accordingly, each interference covariance estimation reference signal of at least the first cell reference signals 315 and the second cell reference signals 320 may be aligned in time resources, frequency resources, or both, which may support the techniques, methods, and devices described herein with reference to FIG. 2.

In some implementations, the covariance matrix estimation averaging windows 305 may include one or more DMRSs (e.g., one or more DMRS symbols). The one or more DMRS symbols may overlap with one or more interference covariance estimation reference signals (e.g., resources for one or more interference covariance estimation reference signals). In some examples, the interference covariance estimation reference signals may utilize a sequence (e.g., a generation sequence, or the like) that is different from a sequence corresponding to the DMRS symbols. Additionally, or alternatively, the interference covariance estimation reference signals may utilize a same sequence as the DMRS symbols (e.g., a common sequence). Accordingly, (e.g., to mitigate an impact of the DMRS for channel estimation (ChanEst) and covariance matrix estimation (RnnEst)), a device may refrain from transmitting the interference covariance estimation reference signals during a DMRS symbol (e.g., may skip the DMRS symbol). In such examples, the device may transmit the interference covariance estimation reference signals within a set of the windows 305 which contain DMRSs to enable other cells to capture the interfering interference covariance estimation reference signals in one or more interference covariance estimation reference signal locations (e.g., transmission occasions) within that window.

For an example, the covariance matrix estimation averaging window 305-a may include a DMRS symbol during a slot 325. Accordingly, a network entity associated with a first cell may refrain from outputting an interference covariance estimation reference signal during a slot 325, where a first transmission occasion of a set of interference covariance estimation reference signals also corresponds to the slot 325. Additionally, or alternatively, the network entity may output one or more interference covariance estimation reference signals during one or more subsequent transmission occasions of the set of interference covariance estimation reference signals during to symbols that occur after the slot 325.

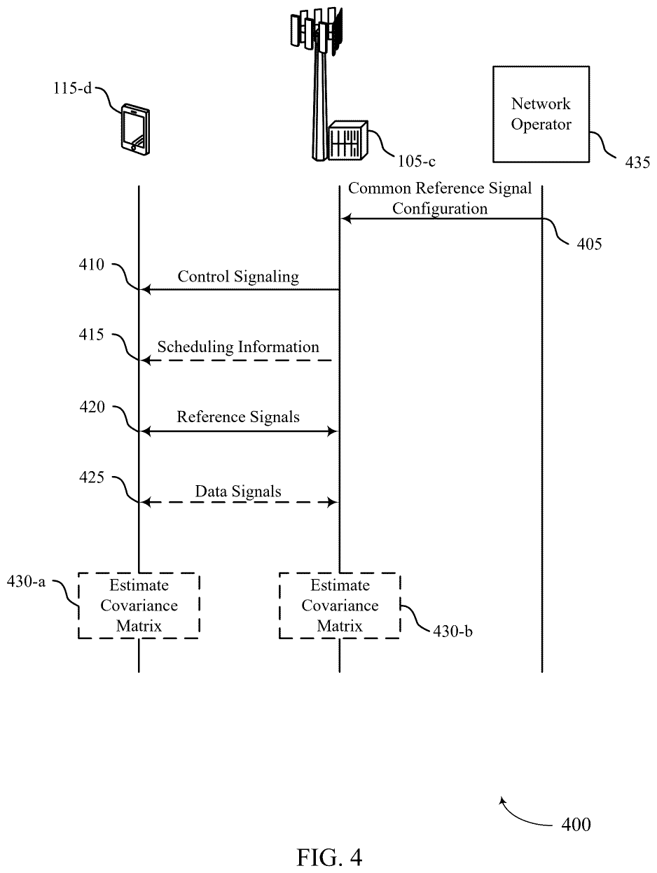

FIG. 4 shows an example of a process flow 400 that supports common interference covariance estimation reference signal configuration across wireless communication cells in accordance with one or more aspects of the present disclosure. Aspects of the process flow 400 may implement or be implemented or be implemented by aspects of the wireless communications system 100, the wireless communications system 200, or both. For example, the process flow 400 may include a network entity 105c, a network operator 435, and a UE 115d, which may be examples of the network entity 105 and the UEs 115, respectively, as described with reference to FIGS. 1-3. The network operator 435 may represent an example of a network entity 105, a server, or some other node or device that is coupled with the network entity 105c and one or more other network entities 105 via one or more backhaul communication links, such as the backhaul communication links 120 described with reference to FIG. 1.

In the following description of the process flow 400, the operations between the network entity 105c, the UE 115d, and the network operator 435 may be performed in different orders or at different times. Some operations may also be left out of the process flow 400, or other operations may be added. Although the network entity 105c, the UE 115d, and the network operator 435 are shown performing the operations of the process flow 400, some aspects of some operations may also be performed by one or more other wireless devices.

At 405, the network operator 435 may output, and the network entity 105-c may obtain, control signaling indicating a common interference covariance estimation reference signal configuration (e.g., an inter-cell reference signal configuration for a set of multiple reference signals, or an Rnn reference signal configuration) further described herein with reference to FIGS. 2 and 3. The control signaling may be RRC signaling, or the like. The control signaling may indicate a set of multiple transmission occasions for one or more interference covariance estimation reference signals corresponding to the common interference covariance estimation reference signal configuration. The common interference covariance estimation reference signal configuration may correspond to (e.g., be common to) multiple devices associated with multiple neighboring cells. For example, the common interference covariance estimation reference signal configuration may allocate multiple interference covariance estimation reference signal transmission occasions for a first cell associated with the network entity 105c and a second cell associated (e.g., a second cell associated with one or more network entities different than the network entity 105c, not pictured in FIG. 4).

In some implementations, the common interference covariance estimation reference signal configuration may be based on a time offset, a frequency offset, or both according to a common time and frequency resource grid. In such implementations, the time offset may indicate an offset quantity of time (e.g., duration) from an initial time domain index of the common time and frequency resource grid, and each interference covariance estimation reference signal transmission occasions may be based on the offset with respect to a slot. The frequency offset may indicate an offset in frequency from an initial frequency domain index (e.g., a common reference point) of the common time and frequency resource grid. As such, the interference covariance estimation reference signal transmission occasions according to the common interference covariance estimation reference signal configuration may be based on the time offset, the frequency offset, or both, which may be described in further detail elsewhere herein, including with reference to FIG. 3.

At 410, the network entity 105c may output control signaling indicating the common interference covariance estimation reference signal configuration to at least the UE 115d. That is, the network entity 105c may forward the indication of the common interference covariance estimation reference signal configuration to the UE 115d (e.g., and one or more other UEs 115 within a cell of the network entity 105c), thus indicating the multiple interference covariance estimation reference signal transmission occasions to the UE 115d. The control signaling of 410 may be RRC signaling, or some other type of control signaling.

At 415, in some examples, the network entity 105c may transmit scheduling information to at least the UE 115d. The scheduling information may schedule (e.g., allocate resource for) one or more PXSCH occasions. For example, the network entity 105c may output scheduling information scheduling multiple PUSCH occasions, among other examples. In such examples, the interference covariance estimation reference signal transmission occasions may correspond to the one or more PXSCH occasions (e.g., the interference covariance estimation reference signals may be transmitted within a time domain and frequency domain resource allocation of PXSCH).

Additionally, or alternatively, the network entity 105c may output a rate matching indication via control signaling (e.g., via DCI, higher layer signaling, or the like). In some examples, further described herein with reference to FIG. 2, the network entity 105c may output the rate matching indication based on one or more communication parameters associated with the UE 115d. For example, the network entity 105c may output the rate matching indication based on a modulation order of the UE 115d, or the like. The rate matching indication may schedule one or more data signal communications (e.g., PXSCH signaling) via the interference covariance estimation reference signal transmission occasions, or may indicate that one or more of the interference covariance estimation reference signal transmission occasions may include data signals rather than interference covariance estimation reference signals.

At 420, the network entity 105c, the UE 115d, or both may communicate one or more interference covariance estimation reference signals within the one or more transmission occasions indicated by the common interference covariance estimation reference signal configuration and scheduled by the scheduling information of 415. For example, the network entity 105c may output, and the UE 115d may obtain, the one or more interference covariance estimation reference signals (e.g., via one or more transmission occasions associated with one or more PDSCH occasions, among other examples). Additionally, or alternatively, the UE 115d may output, and the UE 115-c may obtain, the one or more interference covariance estimation reference signal (e.g., via one or more transmission occasions associated with one or more PUSCH occasions, or the like).

At 425, in some examples, the network entity 105c, the UE 115d, or both may communicate one or more data signals. The data signals may be communicated via multiple PXSCH occasions. For example, the network entity 105c, the UE 115d, or both may communicate the data signals via multiple PXSCH occasions indicated by the scheduling information of 415. Additionally, or alternatively, the network entity 105c, the UE 115d, or both may communicate the data signaling via one or more interference covariance estimation reference signal transmission occasions corresponding to the PXSCH occasion allocation (e.g., rate matching the data signals onto the interference covariance estimation reference signal transmission occasions), one or more different PXCH occasions, or both based on the indication of 425, a predefined rule, or both. In such examples, the data signals communicated via the interference covariance estimation reference signal transmission occasions may be associated with an estimation of a interference covariance matrix estimation.

At 430-a, in some examples, the UE 115d may estimate an interference covariance matrix based on receiving the interference covariance estimation reference signals from the network entity 105c, one or more data signals within one or more interference covariance estimation reference signal transmission occasions, or both. That is, the UE 115d may obtain, via the interference covariance estimation reference signals, interference information associated with the second cell (e.g., and one or more additional cells different than the first cell and the second cell) such as interference patterns (e.g., bursty interference patterns), one or more FDRAs, one or more PRG configurations, or the like, and may accordingly estimate the interference covariance matrix based on the interference information. Additionally, or alternatively, the UE 115d may obtain (e.g., derive, among other examples) interference information based on obtaining the data signals. For example, the data signals may be transmitted by one or more devices of the second cell, and may accordingly indicate interference (e.g., interference patterns, interfering resources, or both) associated with the second cell, and the UE 115d may estimate the interference covariance matrix based on the interference information derived from the data signals.

At 430-b, in some examples, the network entity 105c may estimate an interference covariance matrix based on receiving the interference covariance estimation reference signals from the UE 115d, one or more data signals within one or more interference covariance estimation reference signal transmission occasions, or both. In some examples, the interference covariance matrix may represent interference (e.g., bursty interference, among other examples) associated with one or more different cells of a group of neighboring cells. For example, the interference covariance matrix of 425-a may capture and indicate interference induced by the second cell, among other cells.

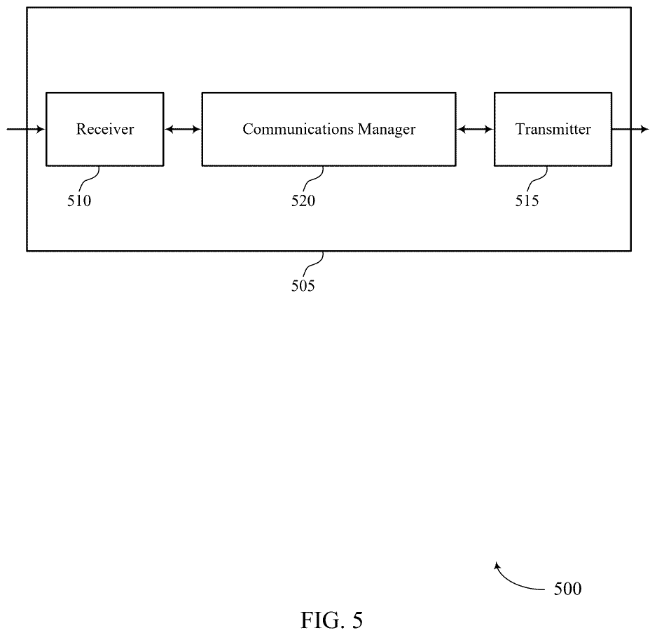

FIG. 5 shows a block diagram 500 of a device 505 that supports common interference covariance estimation reference signal configuration across wireless communication cells in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of common interference covariance estimation reference signal configuration across wireless communication cells as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for obtaining first control signaling that indicates an inter-cell reference signal configuration for a set of multiple reference signals associated with estimation of a covariance matrix, where the inter-cell reference signal configuration allocates a set of multiple transmission occasions for transmission of the set of multiple reference signals within a first cell including the network entity and one or more second cells different from the first cell, and where the set of multiple transmission occasions are at least partially overlapping in time and frequency. The communications manager 520 is capable of, configured to, or operable to support a means for outputting, in accordance with the inter-cell reference signal configuration, second control signaling that indicates the set of multiple transmission occasions for the set of multiple reference signals. The communications manager 520 is capable of, configured to, or operable to support a means for communicating, with one or more UEs within the first cell of the network entity and via one or more transmission occasions of the set of multiple transmission occasions in accordance with the first control signaling and the second control signaling, one or more reference signals of the set of multiple reference signals for the estimation of the covariance matrix.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing and more efficient utilization of communication resources, among other benefits.

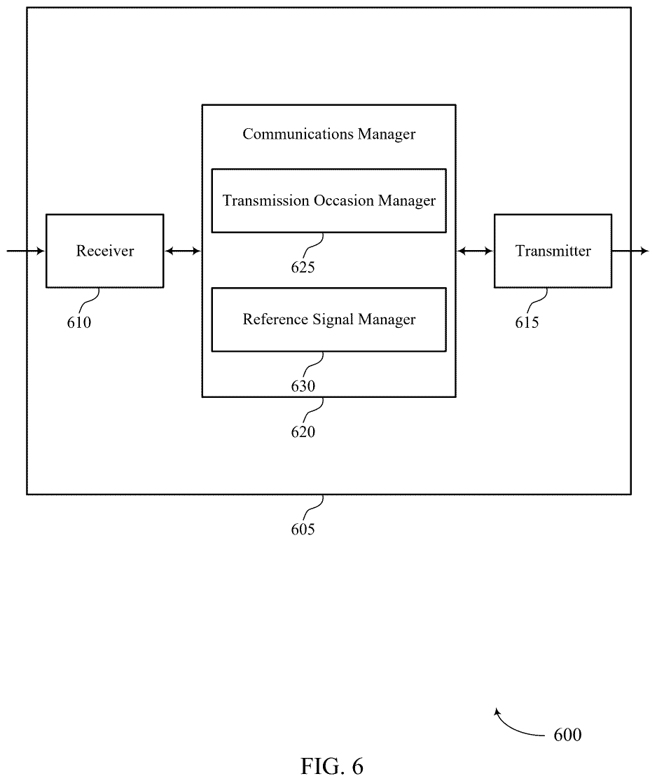

FIG. 6 shows a block diagram 600 of a device 605 that supports common interference covariance estimation reference signal configuration across wireless communication cells in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of common interference covariance estimation reference signal configuration across wireless communication cells as described herein. For example, the communications manager 620 may include a transmission occasion manager 625 a reference signal manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The transmission occasion manager 625 is capable of, configured to, or operable to support a means for obtaining first control signaling that indicates an inter-cell reference signal configuration for a set of multiple reference signals associated with estimation of a covariance matrix, where the inter-cell reference signal configuration allocates a set of multiple transmission occasions for transmission of the set of multiple reference signals within a first cell including the network entity and one or more second cells different from the first cell, and where the set of multiple transmission occasions are at least partially overlapping in time and frequency. The transmission occasion manager 625 is capable of, configured to, or operable to support a means for outputting, in accordance with the inter-cell reference signal configuration, second control signaling that indicates the set of multiple transmission occasions for the set of multiple reference signals. The reference signal manager 630 is capable of, configured to, or operable to support a means for communicating, with one or more UEs within the first cell of the network entity and via one or more transmission occasions of the set of multiple transmission occasions in accordance with the first control signaling and the second control signaling, one or more reference signals of the set of multiple reference signals for the estimation of the covariance matrix.

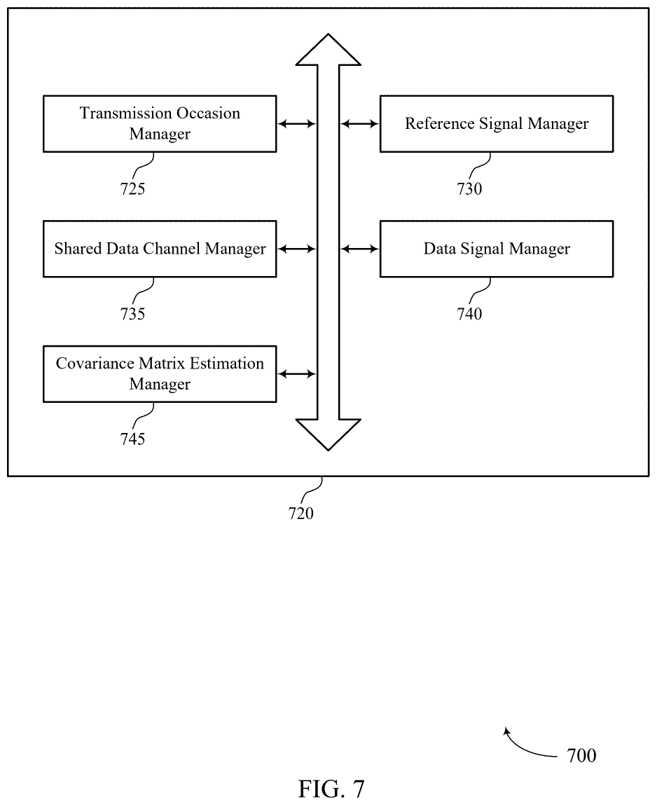

FIG. 7 shows a block diagram 700 of a communications manager 720 that supports common interference covariance estimation reference signal configuration across wireless communication cells in accordance with one or more aspects of the present disclosure. The communications manager 720 may be an example of aspects of a communications manager 520, a communications manager 620, or both, as described herein. The communications manager 720, or various components thereof, may be an example of means for performing various aspects of common interference covariance estimation reference signal configuration across wireless communication cells as described herein. For example, the communications manager 720 may include a transmission occasion manager 725, a reference signal manager 730, a shared data channel manager 735, a data signal manager 740, a covariance matrix estimation manager 745, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The transmission occasion manager 725 is capable of, configured to, or operable to support a means for obtaining first control signaling that indicates an inter-cell reference signal configuration for a set of multiple reference signals associated with estimation of a covariance matrix, where the inter-cell reference signal configuration allocates a set of multiple transmission occasions for transmission of the set of multiple reference signals within a first cell including the network entity and one or more second cells different from the first cell, and where the set of multiple transmission occasions are at least partially overlapping in time and frequency. In some examples, the transmission occasion manager 725 is capable of, configured to, or operable to support a means for outputting, in accordance with the inter-cell reference signal configuration, second control signaling that indicates the set of multiple transmission occasions for the set of multiple reference signals. The reference signal manager 730 is capable of, configured to, or operable to support a means for communicating, with one or more UEs within the first cell of the network entity and via one or more transmission occasions of the set of multiple transmission occasions in accordance with the first control signaling and the second control signaling, one or more reference signals of the set of multiple reference signals for the estimation of the covariance matrix.

In some examples, the shared data channel manager 735 is capable of, configured to, or operable to support a means for outputting scheduling information that schedules communications, within the first cell, via one or more shared data channels and that schedules transmissions of the one or more reference signals of the set of multiple reference signals via the one or more transmission occasions of the set of multiple transmission occasions in accordance with the inter-cell reference signal configuration.

In some examples, to support communicating with the one or more UEs within the first cell, the shared data channel manager 735 is capable of, configured to, or operable to support a means for outputting the communications via a downlink shared data channel of the one or more shared data channels in accordance with the scheduling information. In some examples, to support communicating with the one or more UEs within the first cell, the reference signal manager 730 is capable of, configured to, or operable to support a means for outputting the one or more reference signals of the set of multiple reference signals via the one or more transmission occasions of the set of multiple transmission occasions in accordance with the inter-cell reference signal configuration and the scheduling information.

In some examples, to support communicating with the one or more UEs within the first cell, the shared data channel manager 735 is capable of, configured to, or operable to support a means for obtaining the communications via an uplink shared data channel of the one or more shared data channels in accordance with the scheduling information. In some examples, to support communicating with the one or more UEs within the first cell, the reference signal manager 730 is capable of, configured to, or operable to support a means for obtaining the one or more reference signals of the set of multiple reference signals via the one or more transmission occasions of the set of multiple transmission occasions in accordance with the inter-cell reference signal configuration and the scheduling information. In some examples, to support communicating with the one or more UEs within the first cell, the covariance matrix estimation manager 745 is capable of, configured to, or operable to support a means for estimating the covariance matrix in accordance with the one or more reference signals of the set of multiple reference signals.

In some examples, to support obtaining the first control signaling, the transmission occasion manager 725 is capable of, configured to, or operable to support a means for obtaining, via the first control signaling, an indication of a time offset, a frequency offset, or both within a common time and frequency resource grid and associated with the inter-cell reference signal configuration, where the time offset includes an offset in time from an initial time domain index of the common time and frequency resource grid and the frequency offset includes an offset in frequency from an initial frequency domain index of the common time and frequency resource grid, and where the set of multiple transmission occasions output via the second control signaling are in accordance with the time offset, the frequency offset, or both.

In some examples, the set of multiple transmission occasions includes a first subset of transmission occasions associated with the first cell and one or more second subsets of transmission occasions associated with the one or more second cells, each transmission occasion of the first subset of transmission occasions at least partially overlapping in time and frequency with a respective transmission occasion in each of the one or more second subsets of transmission occasions in accordance with the common time and frequency resource grid.

In some examples, to support communicating with the one or more UEs within the first cell, the reference signal manager 730 is capable of, configured to, or operable to support a means for communicating, in accordance with the inter-cell reference signal configuration, the one or more reference signals via a first subset of transmission occasions from among the set of multiple transmission occasions allocated for the set of multiple reference signals. In some examples, to support communicating with the one or more UEs within the first cell, the data signal manager 740 is capable of, configured to, or operable to support a means for communicating, in accordance with the inter-cell reference signal configuration and one or more communication parameters associated with one or more data signals, the one or more data signals via a second subset of transmission occasions from among the set of multiple transmission occasions allocated for the set of multiple reference signals.

In some examples, the data signal manager 740 is capable of, configured to, or operable to support a means for outputting third control signaling that schedules communications within the set of multiple transmission occasions and indicates that the communications include the set of multiple reference signals and the one or more data signals.

In some examples, the one or more communication parameters associated with the one or more data signals include a modulation order of the one or more data signals, a quantity of data channel layers associated with the one or more data signals, or both. In some examples, the modulation order of the one or more data signals is in accordance with a location of the one or more UEs within the first cell.

In some examples, the reference signal manager 730 is capable of, configured to, or operable to support a means for refraining from communicating a first reference signal of the set of multiple reference signals within a first symbol of a first transmission occasion of the set of multiple transmission occasions in accordance with the first symbol of the first transmission occasion including a demodulation reference signal. In some examples, the reference signal manager 730 is capable of, configured to, or operable to support a means for communicating one or more second reference signals of the set of multiple reference signals within one or more second symbols of the first transmission occasion of the set of multiple transmission occasions in accordance with the first symbol including the demodulation reference signal and in accordance with an absence of one or more additional demodulation reference signals within the one or more second symbols.

In some examples, to support communicating the one or more reference signals of the set of multiple reference signals, the reference signal manager 730 is capable of, configured to, or operable to support a means for communicating the one or more reference signals with a first subset of UEs from among the one or more UEs within the first cell in accordance with a first location of the first subset of UEs. In some examples, to support communicating the one or more reference signals of the set of multiple reference signals, the reference signal manager 730 is capable of, configured to, or operable to support a means for refraining from communicating the one or more reference signals with a second subset of UEs from among the one or more UEs within the first cell in accordance with a second location of the second subset of UEs.

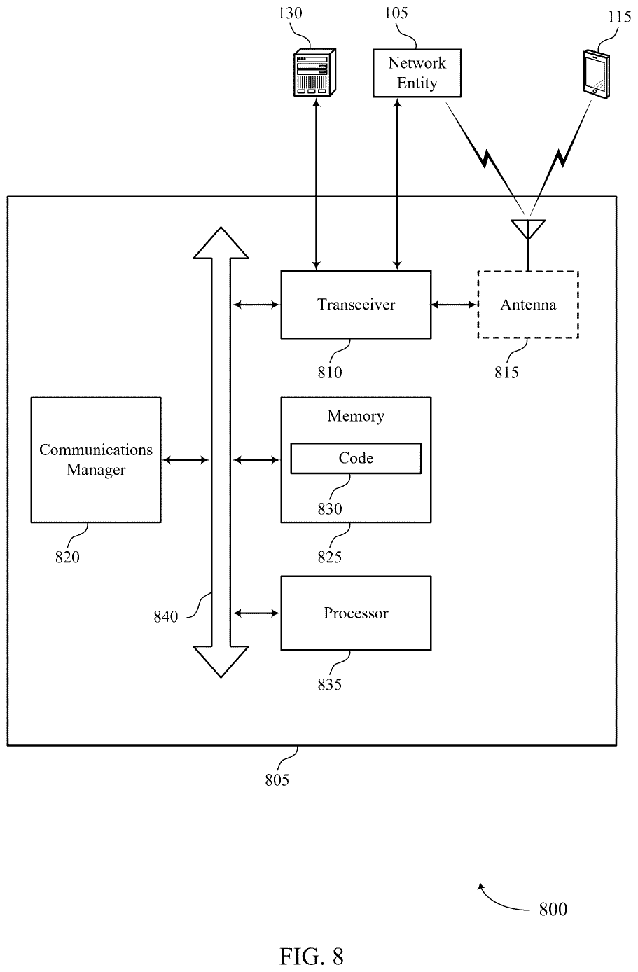

FIG. 8 shows a diagram of a system 800 including a device 805 that supports common interference covariance estimation reference signal configuration across wireless communication cells in accordance with one or more aspects of the present disclosure. The device 805 may be an example of or include components of a device 505, a device 605, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting common interference covariance estimation reference signal configuration across wireless communication cells). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for obtaining first control signaling that indicates an inter-cell reference signal configuration for a set of multiple reference signals associated with estimation of a covariance matrix, where the inter-cell reference signal configuration allocates a set of multiple transmission occasions for transmission of the set of multiple reference signals within a first cell including the network entity and one or more second cells different from the first cell, and where the set of multiple transmission occasions are at least partially overlapping in time and frequency. The communications manager 820 is capable of, configured to, or operable to support a means for outputting, in accordance with the inter-cell reference signal configuration, second control signaling that indicates the set of multiple transmission occasions for the set of multiple reference signals. The communications manager 820 is capable of, configured to, or operable to support a means for communicating, with one or more UEs within the first cell of the network entity and via one or more transmission occasions of the set of multiple transmission occasions in accordance with the first control signaling and the second control signaling, one or more reference signals of the set of multiple reference signals for the estimation of the covariance matrix.

By including or configuring the communications manager 820 in accordance with examples as described herein, the device 805 may support techniques for improved communication reliability, more efficient utilization of communication resources, and improved coordination between devices, among other benefits.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of common interference covariance estimation reference signal configuration across wireless communication cells as described herein, or the at least one processor 835 and the at least one memory 825 may be otherwise configured to, individually or collectively, perform or support such operations.

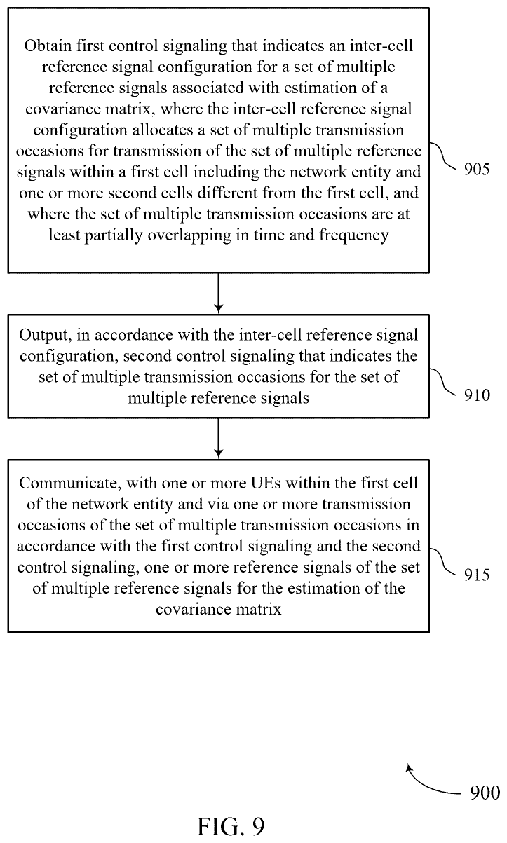

FIG. 9 shows a flowchart illustrating a method 900 that supports common interference covariance estimation reference signal configuration across wireless communication cells in accordance with one or more aspects of the present disclosure. The operations of the method 900 may be implemented by a network entity or its components as described herein. For example, the operations of the method 900 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 905, the method may include obtaining first control signaling that indicates an inter-cell reference signal configuration for a set of multiple reference signals associated with estimation of a covariance matrix, where the inter-cell reference signal configuration allocates a set of multiple transmission occasions for transmission of the set of multiple reference signals within a first cell including the network entity and one or more second cells different from the first cell, and where the set of multiple transmission occasions are at least partially overlapping in time and frequency. The operations of 905 may be performed in accordance with examples as disclosed herein. In some examples, aspects of the operations of 905 may be performed by a transmission occasion manager 725 as described with reference to FIG. 7.

At 910, the method may include outputting, in accordance with the inter-cell reference signal configuration, second control signaling that indicates the set of multiple transmission occasions for the set of multiple reference signals. The operations of 910 may be performed in accordance with examples as disclosed herein. In some examples, aspects of the operations of 910 may be performed by a transmission occasion manager 725 as described with reference to FIG. 7.

At 915, the method may include communicating, with one or more user equipment (UEs) within the first cell of the network entity and via one or more transmission occasions of the set of multiple transmission occasions in accordance with the first control signaling and the second control signaling, one or more reference signals of the set of multiple reference signals for the estimation of the covariance matrix. The operations of 915 may be performed in accordance with examples as disclosed herein. In some examples, aspects of the operations of 915 may be performed by a reference signal manager 730 as described with reference to FIG. 7.

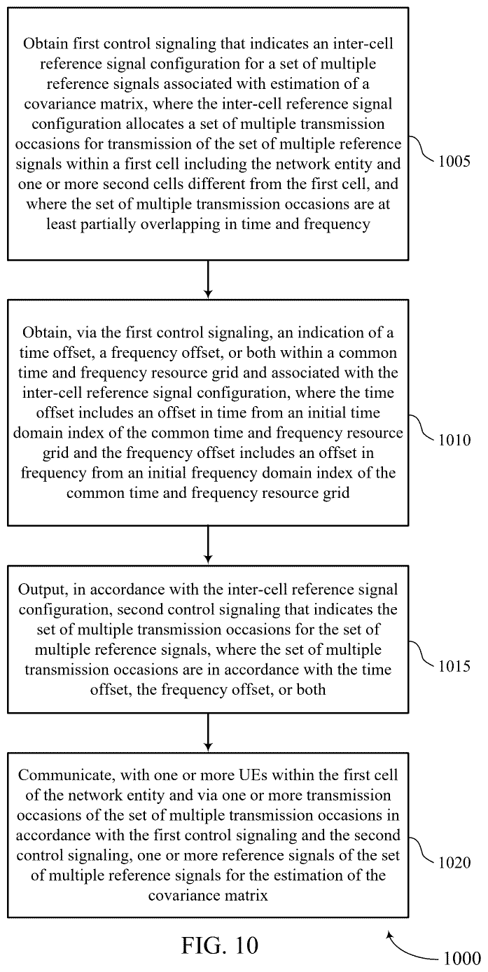

FIG. 10 shows a flowchart illustrating a method 1000 that supports common interference covariance estimation reference signal configuration across wireless communication cells in accordance with one or more aspects of the present disclosure. The operations of the method 1000 may be implemented by a network entity or its components as described herein. For example, the operations of the method 1000 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1005, the method may include obtaining first control signaling that indicates an inter-cell reference signal configuration for a set of multiple reference signals associated with estimation of a covariance matrix, where the inter-cell reference signal configuration allocates a set of multiple transmission occasions for transmission of the set of multiple reference signals within a first cell including the network entity and one or more second cells different from the first cell, and where the set of multiple transmission occasions are at least partially overlapping in time and frequency. The operations of 1005 may be performed in accordance with examples as disclosed herein. In some examples, aspects of the operations of 1005 may be performed by a transmission occasion manager 725 as described with reference to FIG. 7.

At 1010, the method may include obtaining, via the first control signaling, an indication of a time offset, a frequency offset, or both within a common time and frequency resource grid and associated with the inter-cell reference signal configuration, where the time offset includes an offset in time from an initial time domain index of the common time and frequency resource grid and the frequency offset includes an offset in frequency from an initial frequency domain index of the common time and frequency resource grid. The operations of 1010 may be performed in accordance with examples as disclosed herein. In some examples, aspects of the operations of 1010 may be performed by a transmission occasion manager 725 as described with reference to FIG. 7.

At 1015, the method may include outputting, in accordance with the inter-cell reference signal configuration, second control signaling that indicates the set of multiple transmission occasions for the set of multiple reference signals, where the set of multiple transmission occasions are in accordance with the time offset, the frequency offset, or both. The operations of 1015 may be performed in accordance with examples as disclosed herein. In some examples, aspects of the operations of 1015 may be performed by a transmission occasion manager 725 as described with reference to FIG. 7.

At 1020, the method may include communicating, with one or more user equipment (UEs) within the first cell of the network entity and via one or more transmission occasions of the set of multiple transmission occasions in accordance with the first control signaling and the second control signaling, one or more reference signals of the set of multiple reference signals for the estimation of the covariance matrix. The operations of 1020 may be performed in accordance with examples as disclosed herein. In some examples, aspects of the operations of 1020 may be performed by a reference signal manager 730 as described with reference to FIG. 7.

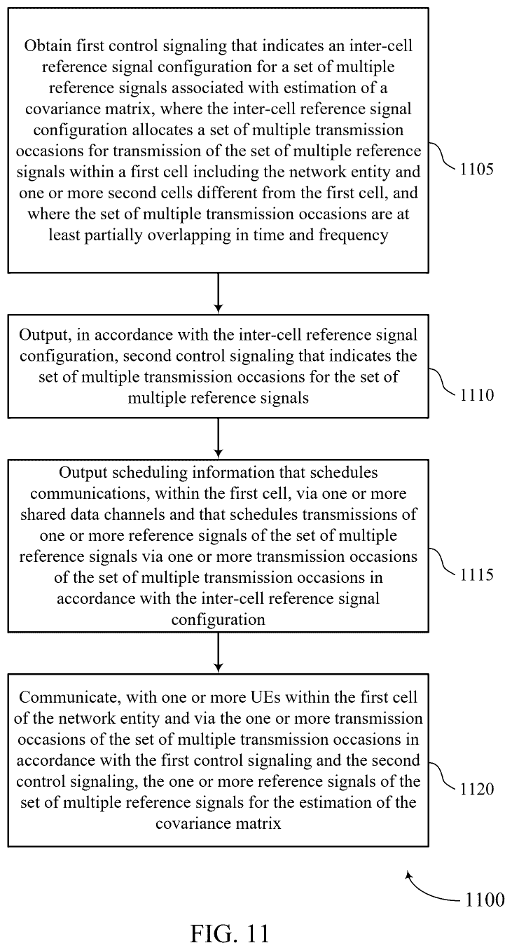

FIG. 11 shows a flowchart illustrating a method 1100 that supports common interference covariance estimation reference signal configuration across wireless communication cells in accordance with one or more aspects of the present disclosure. The operations of the method 1100 may be implemented by a network entity or its components as described herein. For example, the operations of the method 1100 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1105, the method may include obtaining first control signaling that indicates an inter-cell reference signal configuration for a set of multiple reference signals associated with estimation of a covariance matrix, where the inter-cell reference signal configuration allocates a set of multiple transmission occasions for transmission of the set of multiple reference signals within a first cell including the network entity and one or more second cells different from the first cell, and where the set of multiple transmission occasions are at least partially overlapping in time and frequency. The operations of 1105 may be performed in accordance with examples as disclosed herein. In some examples, aspects of the operations of 1105 may be performed by a transmission occasion manager 725 as described with reference to FIG. 7.

At 1110, the method may include outputting, in accordance with the inter-cell reference signal configuration, second control signaling that indicates the set of multiple transmission occasions for the set of multiple reference signals. The operations of 1110 may be performed in accordance with examples as disclosed herein. In some examples, aspects of the operations of 1110 may be performed by a transmission occasion manager 725 as described with reference to FIG. 7.

At 1115, the method may include outputting scheduling information that schedules communications, within the first cell, via one or more shared data channels and that schedules transmissions of one or more reference signals of the set of multiple reference signals via one or more transmission occasions of the set of multiple transmission occasions in accordance with the inter-cell reference signal configuration. The operations of 1115 may be performed in accordance with examples as disclosed herein. In some examples, aspects of the operations of 1115 may be performed by a shared data channel manager 735 as described with reference to FIG. 7.

At 1120, the method may include communicating, with one or more user equipment (UEs) within the first cell of the network entity and via the one or more transmission occasions of the set of multiple transmission occasions in accordance with the first control signaling and the second control signaling, the one or more reference signals of the set of multiple reference signals for the estimation of the covariance matrix. The operations of 1120 may be performed in accordance with examples as disclosed herein. In some examples, aspects of the operations of 1120 may be performed by a reference signal manager 730 as described with reference to FIG. 7. The following provides an overview of aspects of the present disclosure:

Aspect 1: A method for wireless communications by a network entity, comprising: obtaining first control signaling that indicates an inter-cell reference signal configuration for a plurality of reference signals associated with estimation of a covariance matrix, wherein the inter-cell reference signal configuration allocates a plurality of transmission occasions for transmission of the plurality of reference signals within a first cell comprising the network entity and one or more second cells different from the first cell, and wherein the plurality of transmission occasions are at least partially overlapping in time and frequency; outputting, in accordance with the inter-cell reference signal configuration, second control signaling that indicates the plurality of transmission occasions for the plurality of reference signals; and communicating, with one or more UEs within the first cell of the network entity and via one or more transmission occasions of the plurality of transmission occasions in accordance with the first control signaling and the second control signaling, one or more reference signals of the plurality of reference signals for the estimation of the covariance matrix.

Aspect 2: The method of aspect 1, further comprising: outputting scheduling information that schedules communications, within the first cell, via one or more shared data channels and that schedules transmissions of the one or more reference signals of the plurality of reference signals via the one or more transmission occasions of the plurality of transmission occasions in accordance with the inter-cell reference signal configuration.

Aspect 3: The method of aspect 2, wherein communicating with the one or more UEs within the first cell comprises: outputting the communications via a downlink shared data channel of the one or more shared data channels in accordance with the scheduling information; and outputting the one or more reference signals of the plurality of reference signals via the one or more transmission occasions of the plurality of transmission occasions in accordance with the inter-cell reference signal configuration and the scheduling information.

Aspect 4: The method of aspect 2, wherein communicating with the one or more UEs within the first cell comprises: obtaining the communications via an uplink shared data channel of the one or more shared data channels in accordance with the scheduling information; obtaining the one or more reference signals of the plurality of reference signals via the one or more transmission occasions of the plurality of transmission occasions in accordance with the inter-cell reference signal configuration and the scheduling information; and estimating the covariance matrix in accordance with the one or more reference signals of the plurality of reference signals.

Aspect 5: The method of any of aspects 1 through 4, wherein obtaining the first control signaling comprises: obtaining, via the first control signaling, an indication of a time offset, a frequency offset, or both within a common time and frequency resource grid and associated with the inter-cell reference signal configuration, wherein the time offset comprises an offset in time from an initial time domain index of the common time and frequency resource grid and the frequency offset comprises an offset in frequency from an initial frequency domain index of the common time and frequency resource grid, and wherein the plurality of transmission occasions output via the second control signaling are in accordance with the time offset, the frequency offset, or both.

Aspect 6: The method of aspect 5, wherein the plurality of transmission occasions comprises a first subset of transmission occasions associated with the first cell and one or more second subsets of transmission occasions associated with the one or more second cells, each transmission occasion of the first subset of transmission occasions at least partially overlapping in time and frequency with a respective transmission occasion in each of the one or more second subsets of transmission occasions in accordance with the common time and frequency resource grid.

Aspect 7: The method of aspect 1, wherein communicating with the one or more UEs within the first cell comprises: communicating, in accordance with the inter-cell reference signal configuration, the one or more reference signals via a first subset of transmission occasions from among the plurality of transmission occasions allocated for the plurality of reference signals; and communicating, in accordance with the inter-cell reference signal configuration and one or more communication parameters associated with one or more data signals, the one or more data signals via a second subset of transmission occasions from among the plurality of transmission occasions allocated for the plurality of reference signals.

Aspect 8: The method of aspect 7, further comprising: outputting third control signaling that schedules communications within the plurality of transmission occasions and indicates that the communications comprise the plurality of reference signals and the one or more data signals.

Aspect 9: The method of any of aspects 7 through 8, wherein the one or more communication parameters associated with the one or more data signals comprise a modulation order of the one or more data signals, a quantity of data channel layers associated with the one or more data signals, or both, and the modulation order of the one or more data signals is in accordance with a location of the one or more UEs within the first cell.

Aspect 10: The method of any of aspects 1 through 9, further comprising: refraining from communicating a first reference signal of the plurality of reference signals within a first symbol of a first transmission occasion of the plurality of transmission occasions in accordance with the first symbol of the first transmission occasion including a DMRS; and communicating one or more second reference signals of the plurality of reference signals within one or more second symbols of the first transmission occasion of the plurality of transmission occasions in accordance with the first symbol including the DMRS and in accordance with an absence of one or more additional DMRSs within the one or more second symbols.

Aspect 11: The method of any of aspects 1 through 10, wherein communicating the one or more reference signals of the plurality of reference signals further comprises: communicating the one or more reference signals with a first subset of UEs from among the one or more UEs within the first cell in accordance with a first location of the first subset of UEs; and refraining from communicating the one or more reference signals with a second subset of UEs from among the one or more UEs within the first cell in accordance with a second location of the second subset of UEs.

Aspect 12: A network entity for wireless communications, comprising one or more memories storing processor-executable code, and one or more processors coupled with the one or more memories and individually or collectively operable to execute the code to cause the network entity to perform a method of any of aspects 1 through 11.

Aspect 13: A network entity for wireless communications, comprising at least one means for performing a method of any of aspects 1 through 11.

Aspect 14: A non-transitory computer-readable medium storing code for wireless communications, the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
obtain first control signaling that indicates an inter-cell reference signal configuration for a plurality of reference signals associated with estimation of a covariance matrix, wherein the inter-cell reference signal configuration allocates a plurality of transmission occasions for transmission of the plurality of reference signals within a first cell comprising the network entity and one or more second cells different from the first cell, and wherein the plurality of transmission occasions are at least partially overlapping in time and frequency;
output, in accordance with the inter-cell reference signal configuration, second control signaling that indicates the plurality of transmission occasions for the plurality of reference signals; and
communicate, with one or more user equipment (UEs) within the first cell of the network entity and via one or more transmission occasions of the plurality of transmission occasions in accordance with the first control signaling and the second control signaling, one or more reference signals of the plurality of reference signals for the estimation of the covariance matrix.

2. The network entity of claim 1, wherein the one or more processors are individually or collectively further operable to execute the code to cause the network entity to:
output scheduling information that schedules communications, within the first cell, via one or more shared data channels and that schedules transmissions of the one or more reference signals of the plurality of reference signals via the one or more transmission occasions of the plurality of transmission occasions in accordance with the inter-cell reference signal configuration.

3. The network entity of claim 2, wherein, to communicate with the one or more UEs within the first cell, the one or more processors are individually or collectively operable to execute the code to cause the network entity to:
output the communications via a downlink shared data channel of the one or more shared data channels in accordance with the scheduling information; and
output the one or more reference signals of the plurality of reference signals via the one or more transmission occasions of the plurality of transmission occasions in accordance with the inter-cell reference signal configuration and the scheduling information.

4. The network entity of claim 2, wherein, to communicate with the one or more UEs within the first cell, the one or more processors are individually or collectively operable to execute the code to cause the network entity to:
obtain the communications via an uplink shared data channel of the one or more shared data channels in accordance with the scheduling information;
obtain the one or more reference signals of the plurality of reference signals via the one or more transmission occasions of the plurality of transmission occasions in accordance with the inter-cell reference signal configuration and the scheduling information; and
estimate the covariance matrix in accordance with the one or more reference signals of the plurality of reference signals.

5. The network entity of claim 1, wherein, to obtain the first control signaling, the one or more processors are individually or collectively operable to execute the code to cause the network entity to:
obtain, via the first control signaling, an indication of a time offset, a frequency offset, or both within a common time and frequency resource grid and associated with the inter-cell reference signal configuration, wherein the time offset comprises an offset in time from an initial time domain index of the common time and frequency resource grid and the frequency offset comprises an offset in frequency from an initial frequency domain index of the common time and frequency resource grid, and wherein the plurality of transmission occasions output via the second control signaling are in accordance with the time offset, the frequency offset, or both.

6. The network entity of claim 5, wherein the plurality of transmission occasions comprises a first subset of transmission occasions associated with the first cell and one or more second subsets of transmission occasions associated with the one or more second cells, each transmission occasion of the first subset of transmission occasions at least partially overlapping in time and frequency with a respective transmission occasion in each of the one or more second subsets of transmission occasions in accordance with the common time and frequency resource grid.

7. The network entity of claim 1, wherein, to communicate with the one or more UEs within the first cell, the one or more processors are individually or collectively operable to execute the code to cause the network entity to:
communicate, in accordance with the inter-cell reference signal configuration, the one or more reference signals via a first subset of transmission occasions from among the plurality of transmission occasions allocated for the plurality of reference signals; and
communicate, in accordance with the inter-cell reference signal configuration and one or more communication parameters associated with one or more data signals, the one or more data signals via a second subset of transmission occasions from among the plurality of transmission occasions allocated for the plurality of reference signals.

8. The network entity of claim 7, wherein the one or more processors are individually or collectively further operable to execute the code to cause the network entity to:
output third control signaling that schedules communications within the plurality of transmission occasions and indicates that the communications comprise the plurality of reference signals and the one or more data signals.

9. The network entity of claim 7, wherein:
the one or more communication parameters associated with the one or more data signals comprise a modulation order of the one or more data signals, a quantity of data channel layers associated with the one or more data signals, or both, and
the modulation order of the one or more data signals is in accordance with a location of the one or more UEs within the first cell.

10. The network entity of claim 1, wherein the one or more processors are individually or collectively further operable to execute the code to cause the network entity to:
refrain from communicating a first reference signal of the plurality of reference signals within a first symbol of a first transmission occasion of the plurality of transmission occasions in accordance with the first symbol of the first transmission occasion including a demodulation reference signal; and
communicate one or more second reference signals of the plurality of reference signals within one or more second symbols of the first transmission occasion of the plurality of transmission occasions in accordance with the first symbol including the demodulation reference signal and in accordance with an absence of one or more additional demodulation reference signals within the one or more second symbols.

11. The network entity of claim 1, wherein, to communicate the one or more reference signals of the plurality of reference signals, the one or more processors are individually or collectively further operable to execute the code to cause the network entity to:
communicate the one or more reference signals with a first subset of UEs from among the one or more UEs within the first cell in accordance with a first location of the first subset of UEs; and
refrain from communicating the one or more reference signals with a second subset of UEs from among the one or more UEs within the first cell in accordance with a second location of the second subset of UEs.

12. A method for wireless communications by a network entity, comprising:
obtaining first control signaling that indicates an inter-cell reference signal configuration for a plurality of reference signals associated with estimation of a covariance matrix, wherein the inter-cell reference signal configuration allocates a plurality of transmission occasions for transmission of the plurality of reference signals within a first cell comprising the network entity and one or more second cells different from the first cell, and wherein the plurality of transmission occasions are at least partially overlapping in time and frequency;
outputting, in accordance with the inter-cell reference signal configuration, second control signaling that indicates the plurality of transmission occasions for the plurality of reference signals; and
communicating, with one or more user equipment (UEs) within the first cell of the network entity and via one or more transmission occasions of the plurality of transmission occasions in accordance with the first control signaling and the second control signaling, one or more reference signals of the plurality of reference signals for the estimation of the covariance matrix.

13. The method of claim 12, further comprising:
outputting scheduling information that schedules communications, within the first cell, via one or more shared data channels and that schedules transmissions of the one or more reference signals of the plurality of reference signals via the one or more transmission occasions of the plurality of transmission occasions in accordance with the inter-cell reference signal configuration.

14. The method of claim 13, wherein communicating with the one or more UEs within the first cell comprises:
outputting the communications via a downlink shared data channel of the one or more shared data channels in accordance with the scheduling information; and
outputting the one or more reference signals of the plurality of reference signals via the one or more transmission occasions of the plurality of transmission occasions in accordance with the inter-cell reference signal configuration and the scheduling information.

15. The method of claim 13, wherein communicating with the one or more UEs within the first cell comprises:
obtaining the communications via an uplink shared data channel of the one or more shared data channels in accordance with the scheduling information;
obtaining the one or more reference signals of the plurality of reference signals via the one or more transmission occasions of the plurality of transmission occasions in accordance with the inter-cell reference signal configuration and the scheduling information; and
estimating the covariance matrix in accordance with the one or more reference signals of the plurality of reference signals.

16. The method of claim 12, wherein obtaining the first control signaling comprises:
obtaining, via the first control signaling, an indication of a time offset, a frequency offset, or both within a common time and frequency resource grid and associated with the inter-cell reference signal configuration, wherein the time offset comprises an offset in time from an initial time domain index of the common time and frequency resource grid and the frequency offset comprises an offset in frequency from an initial frequency domain index of the common time and frequency resource grid, and wherein the plurality of transmission occasions output via the second control signaling are in accordance with the time offset, the frequency offset, or both.

17. The method of claim 16, wherein the plurality of transmission occasions comprises a first subset of transmission occasions associated with the first cell and one or more second subsets of transmission occasions associated with the one or more second cells, each transmission occasion of the first subset of transmission occasions at least partially overlapping in time and frequency with a respective transmission occasion in each of the one or more second subsets of transmission occasions in accordance with the common time and frequency resource grid.

18. The method of claim 12, wherein communicating with the one or more UEs within the first cell comprises:
communicating, in accordance with the inter-cell reference signal configuration, the one or more reference signals via a first subset of transmission occasions from among the plurality of transmission occasions allocated for the plurality of reference signals; and
communicating, in accordance with the inter-cell reference signal configuration and one or more communication parameters associated with one or more data signals, the one or more data signals via a second subset of transmission occasions from among the plurality of transmission occasions allocated for the plurality of reference signals.

19. The method of claim 18, further comprising:
outputting third control signaling that schedules communications within the plurality of transmission occasions and indicates that the communications comprise the plurality of reference signals and the one or more data signals.

20. A network entity for wireless communications, comprising:
means for obtaining first control signaling that indicates an inter-cell reference signal configuration for a plurality of reference signals associated with estimation of a covariance matrix, wherein the inter-cell reference signal configuration allocates a plurality of transmission occasions for transmission of the plurality of reference signals within a first cell comprising the network entity and one or more second cells different from the first cell, and wherein the plurality of transmission occasions are at least partially overlapping in time and frequency;
means for outputting, in accordance with the inter-cell reference signal configuration, second control signaling that indicates the plurality of transmission occasions for the plurality of reference signals; and
means for communicating, with one or more user equipment (UEs) within the first cell of the network entity and via one or more transmission occasions of the plurality of transmission occasions in accordance with the first control signaling and the second control signaling, one or more reference signals of the plurality of reference signals for the estimation of the covariance matrix.
